(19) United States
(12) Patent Application Publication
(10) Pub. No.: US 2009/0170044 A1
(43) Pub. Date: Jul. 2, 2009

(54) Decoratively illuminating apparatus using a candle

(75) Inventor: Sung-Chul Kang, Bucheon-si (KR)

Correspondence Address: HOLLAND & HART, LLP, P.O BOX 8749, DENVER, CO, 80201, US

(73) Assignee: Samho Ind Co., Ltd, Incheon (KR)

(21) Appl. No.: 12/072,693

(22) Filed: Feb. 27, 2008

(30) Foreign Application Priority Data
Dec. 26, 2007 (KR) 10-2007-0137338

(51) Int. Cl. F21V 37/00; F23D 21/00; F23D 3/16; F21S 19/00; F21V 33/00

(52) U.S. Cl. 431/253; 362/228

(57) ABSTRACT

Disclosed is a decoratively illuminating apparatus using a candle including a candle, a light transparent holder, and a light transparent accommodating seat held in the holder while accommodating the candle. The candle (100) includes a candle body (20), a flammable wick (30) fixed in the center of the candle body (20), and a light transmission line (40) arranged along the flammable wick around the center of the candle body and fixed such that a lower end of the light transmission line is exposed from the lower side of the candle body. The holder (200) includes a bore (210) formed in a top side (201) as a light radiating space, and a light radiating unit (260) having a photosensor (245) to detect light of the flammable wick (30) through the light transmission line (40) and a light source (222) electrically connected to the photosensor (245).

### BACKGROUND

The present invention relates to a decoratively illuminating apparatus using a candle in which a burning flame is generated from a wick for absorbing a melted candle wax to illuminate the surroundings, and more particularly to a decoratively illuminating apparatus using a candle in which the burning flame of the wick is detected by a photosensor via a light transmission line to emit light within a candle support such that the candle support is decorated by a desired colored light.

In general, a candle keeps generating burning flames while absorbing melted candle wax to illuminate surroundings by which a combustible wick implanted into the candle is ignited and burnt.

However, since a conventional candle generates burning flames while the combustible wick which is implanted into the center of the candle simply absorbs the melted candle wax, the conventional candle just illuminates the surroundings, very simply exhibits various decorative illumination, and is not frequently used even when the candle is made for commercial use or as homeware for exhibiting a desired decorative illumination.

### SUMMARY OF THE INVENTION

Therefore, the present invention has been made in view of the above problems, and it is an object of the present invention to provide a decoratively illuminating apparatus using a candle in which the candle is exchangeable, a burning wick that is implanted in the candle its detected by means of light to make a light source radiate light such that a decorative illumination is implemented.

In accordance with an aspect of the present invention, the above and other objects can be accomplished by the provision of a decoratively illuminating apparatus using a candle comprising: a candle; a light transparent holder; and a light transparent accommodating seat held in the holder while accommodating the candle; wherein the candle includes: a candle body; a flammable wick fixed in the center of the candle body; and a light transmission line arranged along the flammable wick around the center of the candle body and fixed such that a lower end of the light transmission line is exposed from the lower side of the candle body; and the holder includes: a bore formed in a top side as a light radiating space; and a light radiating unit having a photosensor to detect light of the flammable wick through the light transmission line and a light source electrically connected to the photosensor.

According to the present invention, a decoratively illuminating apparatus can be realized cheaply and for a long time in response to the burning wick implanted in the candle.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an exploded perspective view illustrating a decoratively illuminating apparatus according to an embodiment of the present invention except for a holder;

FIG. 2 is an exploded perspective view illustrating all of a decoratively illuminating apparatus in FIG. 1; and

FIG. 3 is a sectional view illustrating the holder in which the decoratively illuminating apparatus is mounted.

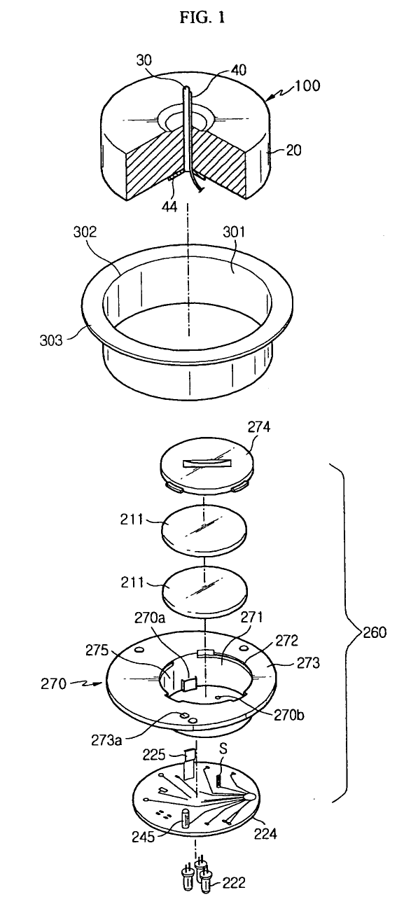

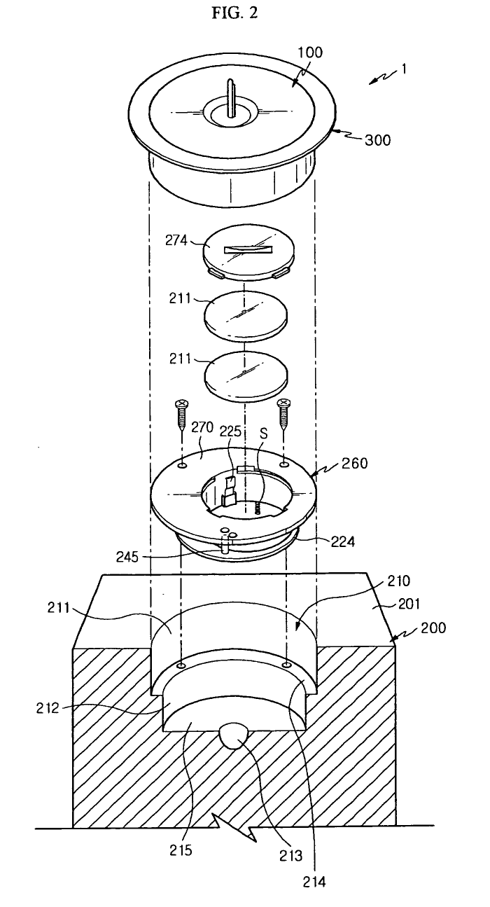

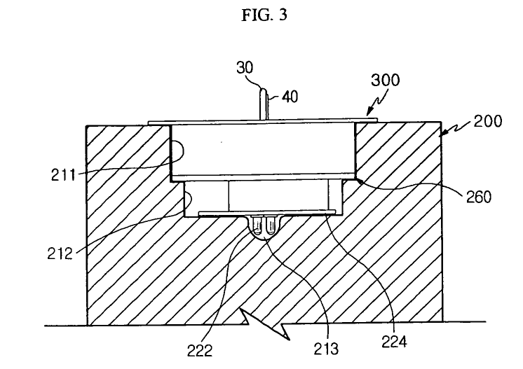

Hereinafter, preferred embodiments of the present invention will be described in detail with reference to FIGS. 1 and 2, as follows.

In FIG. 1, a reference numeral 1 is designated to a decoratively illuminating apparatus using a candle according to an embodiment of the present invention.

The decoratively illuminating apparatus 1 includes a candle 100, a light transparent holder 200, and a light transparent accommodating seat 300 in which the candle is accommodated to be held in the holder 200.

The candle 100, as illustrated in FIGS. 1 and 2, includes a candle body 20, a flammable wick 30 fixed in the center of the candle body 20, a light transmission line (40) arranged along the flammable wick 30 in the vicinity of the center of the candle body 20, and a light shielding cap 44 having a fixing hole to fix the light transmission line 40 when a lower end of the light transmission line 40 is exposed from the lower side of the candle body 20 and attached to the lower side of the candle.

The holder 200 includes a bore 210 formed in a top side 201, and a light radiating unit 260 having a photosensor 245 to detect light of the flammable wick 30 through the light transmission line 40 and a light source 222 electrically connected to the photosensor 245.

The candle body 20 is made of melted candle wax formed into a desired solid shape such as a cylindrical shape as illustrated in the drawings, but the shape of the candle body 20 is not limited to the shape illustrated in the drawings and may be a triangular column shape or a rectangular column shape.

The flammable wick 30 is fixed in the center of the melted candle for constituting the candle body 20 approximately in the vertical direction of the candle body 20. The flammable wick 30, for example, is made of a flammable fiber.

The light transmission line 40 is approximately integrated with the flammable wick 30 to be parallel to the flammable wick 30 in the vicinity of the center of the candle body 20, and is fixed by the candle wax for constituting the candle body 20.

The upper end of the light transmission line 40 is set to be the approximately same level as that of the tip of the flammable wick 30 and the lower end thereof is exposed from the lower side of the candle body 20.

Although the bore 210 as the light radiating space has a circular cavity, the bore 210 may have any other shape sufficient to accommodate the light radiating unit 260 and the accommodating seat 300.

The bore 210 includes a first diameter portion 211, a second diameter portion 212 with a diameter less than that of the first diameter portion, and a third diameter portion 213 with a diameter less than that of the second diameter portion, such that the first to third diameter portions communicate with each other. A first flange 214 is provided between the first diameter portion 211 and the second diameter portion 212, and a second flange 215 is provided between the second diameter portion 212 and the third diameter portion 213.

The accommodating seat 300 is made in the form of an open-topped container and includes a third flange 303 provided in a rim 302 of an entrance 301 thereof.

The internal space of the accommodating seat 300 has a size and a shape such that the candle body 20 is inserted and accommodated therein to keep the erected state, and portions of the seat 300 other than the third flange 303 have sizes and shapes to be inserted into the first diameter portion 211 when the third flange 303 is placed on the top side 210 of the holder 200.

The light radiating unit 260, as illustrated in FIGS. 1 and 2, includes a non-conductive case 270 with an open-topped container shape.

The case 270 includes a fourth flange 273 formed in a rim 272 of an opening 271 and a lid 274 to cover the opening 271.

In an inner space 275 of the case 270, a power supply 221 such as a plate type battery is installed.

Moreover, the light radiating unit 260 includes the photosensor 245 to detect light and heat from the light transmission line 40, electrode terminals (not depicted ground terminal and power terminals) to be electrically connected to the photosensor 245, a plurality of light sources 222 such as LEDs or UV LEDs to receive electrical power from the power supply 221 to radiate light when the power supply 221 is electrically connected to the photosensor 245, and a substrate 224 in which a radiating controller (not shown) for sequentially turning the respective light sources 222 on and off for example every desired time period and for repeatedly controlling the sequential turning on and off of the light sources is mounted.

Here, the photosensor 245 protrudes from the upper side of the substrate 224 and the light sources 222 protrude from the lower side of the substrate 224 and are inserted into the third diameter portion 213 of the bore 210.

Furthermore, in the radiating unit 260, an elastic piece 225 serving as a power terminal to electrically connect the substrate 224 to the power supply 221 has an end connected to a side of the substrate 224 and the other end thereof which protrudes upward to be electrically connected to the power supply 221, and a spring piece S serving as a ground terminal has an end to be electrically connected to the substrate 224 and the other end thereof protruding upward to be electrically connected to the power supply 221.

The accommodating case 270 has holes 270a and 270b to allow the spring piece S and the elastic piece 225 to protrude toward the inner space of the accommodating case 270 so that the substrate 224 is detachably mounted thereto in a snap coupling way.

The fourth flange 273 of the accommodating case 270 has a hole 273a to expose the photosensor 245 and the fourth flange 273 is detachably coupled with the second flange 215 disposed between the second diameter portion 212 and the third diameter portion 213.

In a case of using the decoratively illuminating apparatus 1 using the candle assembled as described above, when the decoratively illuminating apparatus 1 using a candle is placed on a table (not shown), the flammable wick 30 exposed to the outside is ignited to generate burning flame from the flammable wick 30, light from the burning flame is induced to the light transmission line 40 so that the electric power is supplied from the power supply 221 to drive the radiating controller such that the respective light sources 222 are repeatedly and sequentially turned on and off every desired time period, resulting in overlapping light from various colored lights to be mixed with each other.

As a result, the candle body 20, particularly the portion corresponding to the surroundings of the light sources by forming the bore 210 as the light radiating space allows light from the light sources 222 to transmit so effectively that decorative lights in which light is radiated in the order of red, blue, and yellow repeatedly are exhibited, resulting in providing unique aesthetically appearing colored lights to the surroundings of the decoratively illuminating apparatus.

When the candle body 20 is reduced in length so as not to be used further, a new candle 100 according to the embodiment of the present invention is mounted in the accommodating seat 300 to be held in the holder 200 so that the decoratively illuminating apparatus is used again as described above.

Preferably, the candle body may contain an incense component such as aroma or mosquito incense to deodorize, and the holder may be made of one or more of various materials such as polyester, crystal, rock salt, and the like, in the form of Dharma, Buddha, the Virgin Mary, a heart, animals, popular characters, flowers, adult goods, and the like.

We claim:

1. A decoratively illuminating apparatus using a candle comprising:
a candle;
a light transparent holder; and
a light transparent accommodating seat held in the holder and accommodating the candle; wherein
the candle includes:
a candle body;
a flammable wick fixed in a center of the candle body; and
a light transmission line arranged along the flammable wick around the center of the candle body and fixed such that a lower end of the light transmission line is exposed from a lower side of the candle body; and
the holder includes:
a bore formed in a top side as a light radiating space; and
a light radiating unit having a photosensor to detect light of the flammable wick through the light transmission line and a light source electrically connected to the photosensor.

2. The decoratively illuminating apparatus using a candle as claimed in claim 1, wherein the bore is made in a form accommodating the light radiating unit and the accommodating seat.

3. The decoratively illuminating apparatus using a candle as claimed in claim 1, wherein the bore includes a first diameter portion, a second diameter portion less than that of the first diameter portion, and a third diameter portion less than that of the second diameter portion, such that the first to third diameter portions communicate with each other,
the accommodating seat is inserted into the first diameter portion,
the light source is inserted into the third diameter portion, and
the light radiating unit except for the light source is inserted into the second diameter portion.

4. The decoratively illuminating apparatus using a candle as claimed in claim 1, wherein the light radiating unit comprises:
a non-conductive case with an open-topped container shape;
the non-conductive case includes a flange formed in a rim of an opening and a lid to cover the opening; and
a power supply is installed in the non-conductive case.

5. The decoratively illuminating apparatus using a candle as claimed in claim 4, wherein, in the case, the photosensor to detect light and heat from the light transmission line, electrode terminals to be electrically connected to the photosensor, a plurality of light sources to receive electrical power from the power supply to radiate light when the power supply is electrically connected to the photosensor, and a substrate in which a radiating controller for sequentially turning the respective light sources on and off for example every desired time period and for repeatedly controlling the sequential turning on and off of the light sources, are mounted.

6. The decoratively illuminating apparatus using a candle as claimed in claim 5, wherein the photosensor protrudes from the upper side of the substrate and the light sources protrude from the lower side of the substrate, and
in the radiating unit, an elastic piece, serving as a power terminal to electrically connect the substrate to the power supply, has an end connected to a side of the substrate and the other end thereof which protrudes upward to be electrically connected to the power supply, and a spring piece, serving as a ground terminal, has an end to be electrically connected to the substrate and the other end thereof protruding upward to be electrically connected to the power supply.

7. The decoratively illuminating apparatus using a candle as claimed in claim 6, wherein the case has holes to allow the spring piece and the elastic piece to protrude toward the inner space of the case, and the flange of the case has a hole to expose the photosensor.

8. The decoratively illuminating apparatus using a candle as claimed in claim 3, wherein the light radiating unit comprises:
a non-conductive case with an open-topped container shape;
the non-conductive case includes a flange formed in a rim of an opening and a lid to cover the opening; and
a power supply is installed in the non-conductive case.

9. The decoratively illuminating apparatus using a candle as claimed in claim 8, wherein, in the case, the photosensor to detect light and heat from the light transmission line, electrode terminals to be electrically connected to the photosensor, a plurality of light sources to receive electrical power from the power supply to radiate light when the power supply is electrically connected to the photosensor, and a substrate in which a radiating controller for sequentially turning the respective light sources on and off for example every desired time period and for repeatedly controlling the sequential turning on and off of the light sources, are mounted.

10. The decoratively illuminating apparatus using a candle as claimed in claim 9, wherein the photosensor protrudes from the upper side of the substrate and the light sources protrude from the lower side of the substrate, and
in the radiating unit, an elastic piece, serving as a power terminal to electrically connect the substrate to the power supply, has an end connected to a side of the substrate and the other end thereof which protrudes upward to be electrically connected to the power supply, and a spring piece, serving as a ground terminal, has an end to be electrically connected to the substrate and the other end thereof protruding upward to be electrically connected to the power supply.
